(19) United States
(12) Patent Application Publication
(10) Pub. No.: US 2015/0105031 A1
(43) Pub. Date: Apr. 16, 2015

(54) Efficient Whole-Body SAR Estimation

(71) Applicants: Davide Colombi, Stockholm (SE); Jonas Fridén, Molndal (SE); Björn Thors, Taby (SE)

(72) Inventors: Davide Colombi, Stockholm (SE); Jonas Fridén, Molndal (SE); Björn Thors, Taby (SE)

(73) Assignee: Telefonaktiebolaget L M Ericsson(publ), Stockholm (SE)

(21) Appl. No.: 14/395,238

(22) PCT Filed: Apr. 19, 2012
(86) PCT No.: PCT/SE2012/050418

§ 371 Date: Oct. 17, 2014

(51) Int. Cl. H04B 1/38; H04B 17/00

(52) U.S. Cl. CPC H04B 1/3838; H04B 17/0032
USPC 455/73

(57) ABSTRACT

A method for estimating a whole-body Specific Absorption Rate (SAR) caused in a body by electromagnetic fields emitted by a wireless communication device (40), where the body is represented by a phantom (30) and the wireless communication device (40) is positioned in the proximity of the phantom (30), comprises determining a complex electric field in a plurality of points distributed substantially in a single planar or curved surface (31) within the phantom (30), based on measurements of the magnitude of the electric field components in these points, and based on an assumption of constant phase of the electric field components. The method further comprises estimating a whole-body SAR in the phantom (30) based on the determined complex electric field in the plurality of points, and based on propagation of the complex electric field from the plurality of points into the volume of the phantom (30).

### TECHNICAL FIELD

The present embodiments generally relate to exposure estimation related to electromagnetic fields emitted by a wireless communications device and, more particularly, to estimation of whole-body Specific Absorption Rate (SAR) caused in a body by electromagnetic fields emitted by a wireless communications device.

### BACKGROUND

Among the many exposure estimation methods available, Specific Absorption Rate (SAR) measurements are often considered as a reference method. Exposure limits are given for both localized SAR, which is the maximum local SAR averaged over a mall mass, for example any 10 g of contiguous tissue, as well as for whole-body SAR, which is SAR averaged over the total body mass. It is therefore desirable to have access to reliable and standardized localized and whole-body SAR measurement methods.

The conventional way to measure SAR for practical applications is by means of an electric field probe moved by a robot within a model of a body, i.e. a so-called phantom, usually a container filled with a body-tissue equivalent liquid, i.e. a liquid with similar dielectric properties (high loss and high permittivity) as body-tissue. The probe is used to register the amplitude of the vector components of the electric fields induced in the phantom due to electromagnetic fields emitted by the device which is to be measured (e.g. a radio base station or mobile phone). The device under test is placed on or near the surface of the phantom. The amplitude of the electric field vector components is measured, and the mass-averaged SAR value is determined, for example by means of sliding spatial averaging.

A conventional method for SAR measurements is based on a volumetric scan of the entire volume of the phantom. However, this method is relatively time-consuming. In the recently published international standard IEC 62232:2011, “Determination of RF field strength and SAR in the vicinity of radio communication base stations for the purpose of evaluating human exposure”, 2011, a phantom for whole-body SAR measurements of radio base stations (RBS) was defined. According to this specification, SAR shall be measured within a rectangular box-shaped phantom with a length and width of approximately 1.5 m and 0.34 m, respectively. The height of the measurement volume is 0.09 m, which results in a large number of estimation points and lengthy measurements (approximately 13 hours) when a conventional volumetric scan is used.

There is therefore a need for a method that can be used to carry out SAR measurements more rapidly than previous solutions, while still providing accurate results.

### SUMMARY

It is an object to provide a method and a device for quickly and reliably estimating the whole-body SAR caused in a body by electromagnetic fields emitted by a wireless communications device.

An aspect relates to a method for estimating a whole-body Specific Absorption Rate (SAR) caused in a body by electromagnetic fields emitted by a wireless communication device, where the body is represented by a phantom and the wireless communication device is positioned in the proximity of the phantom. The method comprises determining a complex electric field in a plurality of points distributed substantially in a single planar or curved surface within the phantom, based on measurements of the magnitude of the electric field components in these points, and based on an assumption of constant phase of the electric field components. The method further comprises estimating a whole-body SAR in the phantom based on the determined complex electric field in the plurality of points, and based on propagation of the complex electric field from the plurality of points into the volume of the phantom.

Another aspect relates to a SAR estimation device configured to estimate a whole-body SAR caused in a body by electromagnetic fields emitted by a wireless communication device, where the body is represented by a phantom and the wireless communication device is placed in the proximity of the phantom. The SAR estimation device comprises a complex field determiner configured to determine a complex electric field in a plurality of points distributed substantially in a single planar or curved surface within the phantom, based on measurements of the magnitude of the electric field components in these points, and based on an assumption of constant phase of the electric field components. The SAR estimation device also comprises a SAR estimator configured to estimate a whole-body SAR in the phantom based on the determined complex electric field in the plurality of points, and based on propagation of the complex electric field from the plurality of points into the volume of the phantom.

A further aspect relates to a SAR estimation system comprising such a SAR estimation device. The SAR estimation system is configured to estimate a whole-body SAR caused in a body by electromagnetic fields emitted by a wireless communication device, where the body is represented by a phantom and the wireless communication device is placed in the proximity of the phantom. The SAR estimation system also comprises an electric field measurement device configured to measure the magnitude of electric field components in a plurality of points distributed substantially in a single planar or curved surface within the phantom.

Yet another aspect relates to a computer program for estimating, when executed by a computer, a whole-body Specific Absorption Rate (SAR) caused in a body by electromagnetic fields emitted by a wireless communication device, where the body is represented by a phantom and the wireless communication device is placed in the proximity of the phantom. The computer program comprises program means configured to determine a complex electric field in a plurality of points distributed substantially in a single planar or curved surface within the phantom, based on measurements of the magnitude of the electric field components in these points, and based on an assumption of constant phase of the electric field components. The computer program further comprises program means configured to estimate a whole-body SAR in the phantom based on the determined complex electric field in the plurality of points, and based on propagation of the complex electric field from the plurality of points into the volume of the phantom.

An advantage of the disclosed embodiments is that the proposed technology significantly reduces the total SAR evaluation time. In addition, the technology is suitable for integration with commercially available SAR measurement systems, without requiring any additional instrumentation. The technology is also suitable for integration with the IEC 62232 standard.

### BRIEF DESCRIPTION OF THE DRAWINGS

The embodiments, together with further objects and advantages thereof, may best be understood by making reference to the following description taken together with the accompanying drawings, in which:

FIG. 1A is a schematic illustration of an example of a SAR measurement setup according to an embodiment;

FIG. 1B is a schematic illustration of an example of a phantom used in the SAR measurement setup of FIG. 1A;

FIG. 2 is a flow chart showing an example of a method for estimation of whole-body SAR according to an embodiment;

FIG. 3 is a flow chart showing a particular example of the estimating SAR step in FIG. 2 according to an embodiment;

FIG. 4 is a flow chart showing a particular example of the determining SAR step in FIG. 3 according to an embodiment;

FIG. 5 is a block diagram of an example of a system for estimation of whole-body SAR according to an embodiment;

FIG. 6 is a block diagram of an example of a device for estimation of whole-body SAR according to an embodiment;

FIG. 7 is a block diagram of an example of the SAR estimator in FIG. 6 according to an embodiment;

FIG. 8 is a block diagram of an example of the SAR determiner in FIG. 7 according to an embodiment; and

FIG. 9 is a block diagram of an example of a computer implementation according to an embodiment.

### DETAILED DESCRIPTION

The present embodiments generally relate to exposure estimation related to electromagnetic fields emitted by a wireless communications device and, more particularly, to estimation of whole-body Specific Absorption Rate (SAR) caused in a body by electromagnetic fields emitted by a wireless communications device.

Throughout the drawings, the same reference numbers are used for similar or corresponding elements.

The time consumption of the conventional procedure, using a volumetric scan of the entire volume of the phantom, is a major issue when measuring whole-body SAR. Some approaches have already been designed to speed up SAR measurements. The solutions proposed by M. Y. Kanda, M. G. Douglas, E. D. Y. Mendivil, M. Ballen, A. V. Gessner, and C.-K. Chou, “Faster determination of mass-averaged SAR from 2-D area scans, “IEEE Trans. Microwave Theory Tech., vol. 52, pp. 2013-2020, August 2004, and O. Merckel, J.-C. Bolomey, and G. Fleury, “Parametric model approach for rapid SAR measurements”, in Proceedings of the 21^{st} IEEE Instrumentation and Measurement Technology Conference, (USA), pp. 178-183, 2004, rely on specific antenna designs or require non-standard equipment in addition to the commercially available SAR measurements systems. In addition, these methods were designed and tested for localized SAR measurements only.

Patent EP 1 615 041 discloses a device for measuring the SAR value of a cellular telephone, but the device described in that document measures both the amplitude and the phase of an electric or magnetic field.

A method valid for whole-body SAR measurements was described in WO 2008/051125. The method is suitable for phantoms with flat surfaces and is based on magnitude measurements of the electric field in points on two surfaces within the phantom.

A different approach for whole-body SAR measurements, valid for generic phantom shapes, was described by D. Colombi, B. Thors and B. L. G. Jonsson, “Experimental whole-body SAR assessments by means of surface scan with no phase information”, in The Bioelectromagnetics Society 33^{rd} Annual Meeting, (Canada), June 2011. This method is based on magnitude measurements of the tangential components of the electric field over the phantom surface and an integral equation technique.

The herein proposed technology instead relates to a method where the magnitude of the electric field components is measured over a single surface within the phantom. The phase of the electric field components is assumed constant. This assumption is justified because of the high loss and high permittivity of the tissue simulating liquid. The whole-body SAR is then estimated from the determined complex electric field inside the phantom, where the complex electric field determined in the single surface or plane is propagated into the volume of the phantom.

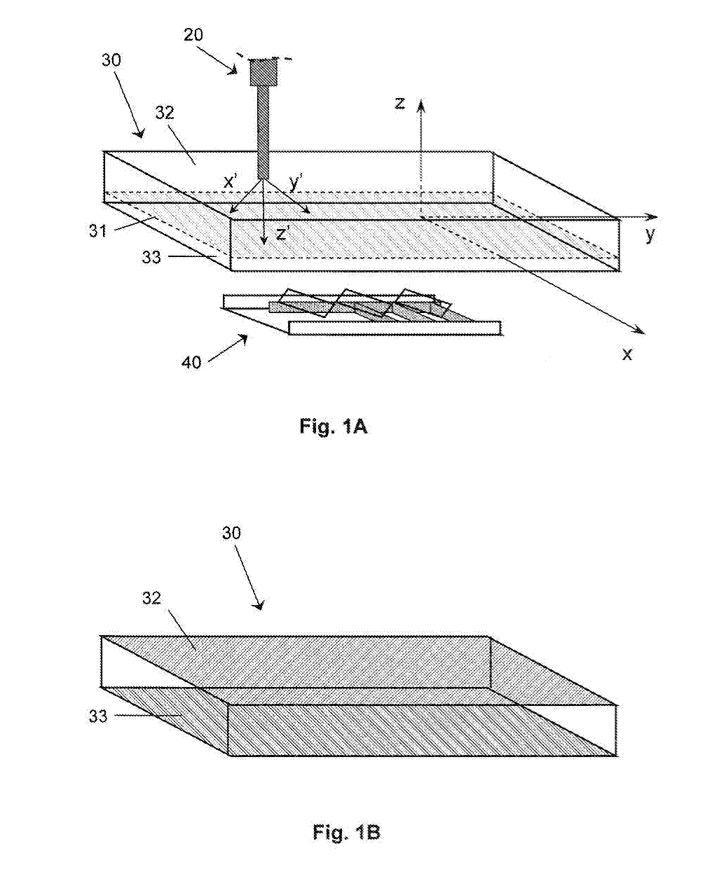

FIG. 1A is a schematic illustration of a SAR measurement setup to which the present embodiments can be applied. The embodiments work well with commercially available SAR measurement systems, but other measurement systems may also be used. A wireless communication device 40 which is to be tested for electric emissions is arranged in the proximity of a phantom 30, i.e. a model of the human body. The embodiments may be used for virtually any device which emits electromagnetic fields, but the embodiments will be described using a radio base station as the device 40. Examples of other devices to which the embodiments can be applied are mobile telephones, cordless telephones, cordless microphones, auxiliary broadcast devices and radio parts intended for computers.

The phantom 30 may be of many kinds, but is in the embodiment shown in FIG. 1A represented by a container filled with a body-tissue equivalent liquid, i.e. a liquid with similar dielectric properties (high loss and high permittivity) as body-tissue. The phantom 30 is preferably box-shaped as defined by the international standard IEC 62232:2011 (see above), but other phantoms may also be used. An example of a box-shaped phantom is schematically illustrated in FIG. 1B.

An electric field measurement device 20 is arranged to measure the magnitude of the electric field components inside the phantom 30, caused by the wireless communication device 40. In conventional SAR measurements, the probe of the measurement device 20 would have been moved over points in the entire volume of the phantom 30, by means of which the complex electric field in the phantom 30 would have been determined. This is a method which works well, but is inherently time-consuming, something that will be particularly bothersome in whole-body SAR measurements.

In the method of the present disclosure, the magnitude measurements of the electric field components are instead performed in a number of points belonging to a single surface 31 within the phantom 30. As shown in FIG. 1A, in a preferred embodiment the single surface 31 is substantially a flat or planar surface but may also be curved. By way of example, the single surface 31 is preferably located at z=z₀ with reference to the coordinate system x, y, z shown in FIG. 1A.

Since the method of the present disclosure only measures the electric field in a single surface 31 as opposed to measurements carried out over the entire volume of the phantom 30, significant benefits are obtained regarding the time needed for the measurements. In order to further minimize the time needed for the actual measurements, only the magnitude (amplitude) of the electric field is measured in the points of the single surface 31.

Two coordinate systems are defined in FIG. 1A. The unprimed coordinates, x, y, and z, respectively represent tangential and normal components with respect to the phantom surface. The primed coordinates, x′, y′, and z′, given in the reference system of the probe, are aligned with the probe sensors. The measured electric field components provided by the measurement system are hereafter given in the primed coordinate system.

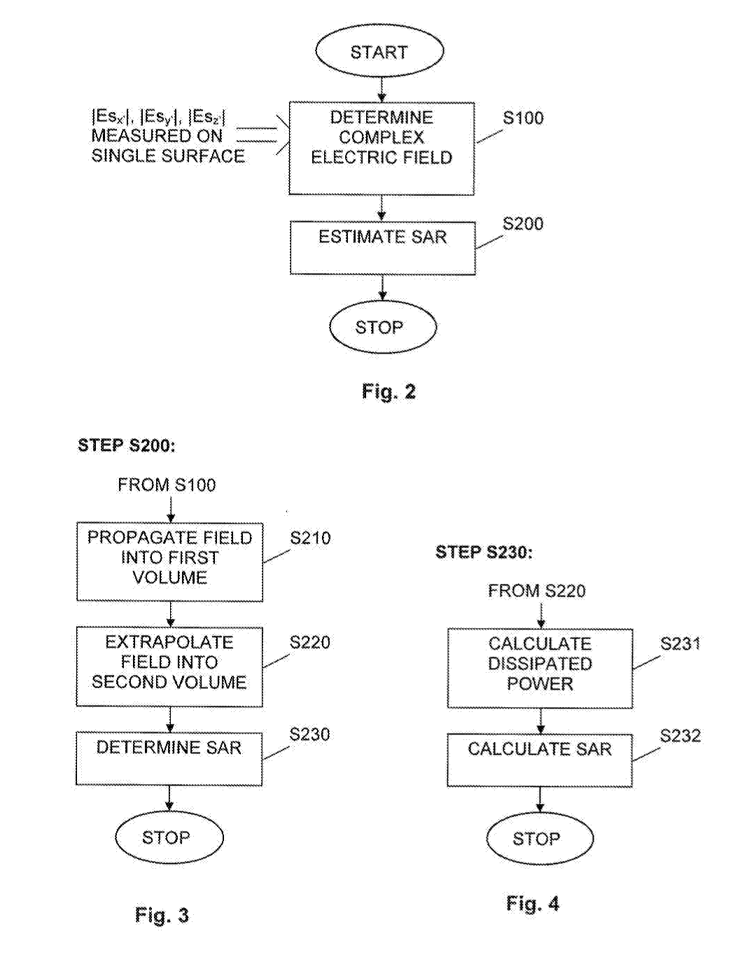

FIG. 2 is a flow chart showing an embodiment of a method for estimating a whole-body SAR caused in a body by electromagnetic fields emitted by a wireless communication device 40, where the body is represented by a phantom 30 and the wireless communication device 40 is positioned in the proximity of the phantom 30. The method comprises a first step S100 of determining a complex electric field in a plurality of points distributed substantially in a single planar or curved surface 31 within the phantom 30, based on measurements of the magnitude of the electric field components in these points, and based on an assumption of constant phase of the electric field components. The method further comprises a second step S200 of estimating a whole-body SAR in the phantom 30 based on the determined complex electric field in the plurality of points, and based on propagation of the complex electric field from the plurality of points into the volume of the phantom 30.

In a particular example, the complex electric field is determined based on measurements of the magnitude of the root-mean-squared (rms) electric field components (|E_{S}_{_{x′}}|, |E_{S}_{_{y′}}|, |E_{S}_{_{z′}}|) in a number of points belonging to a single surface in the proximity of the bottom surface of the phantom. A constant phase assumption is then employed and the complex field over the surface, Ē_{S}, can therefore be expressed as

$$\begin{matrix}{\overline{E}}_{S} = {E}_{{S}_{{x}^{′}}} {\hat{\overline{x}}}^{′} + {E}_{{S}_{{y}^{′}}} {\hat{\overline{y}}}^{′} + {E}_{{S}_{{z}^{′}}} {\hat{\overline{\overline{z}}}}^{′} \\ = \vert {E}_{{S}_{{x}^{′}}} \vert {\hat{\overline{x}}}^{′} + \vert {E}_{{S}_{{y}^{′}}} \vert {\hat{\overline{y}}}^{′} + \vert {E}_{{S}_{{z}^{′}}} \vert {\hat{\overline{\overline{z}}}}^{′}\end{matrix} \qquad ( 1 )$$

The complex field inside the phantom at a generic point, Ē(x, y, z), is obtained from Ē_{S} using the propagation function T:

|E_{x′(x, y, z)}|=|T(z)E_{S}_{_{x′}}(x, y)|

|E_{y′(x, y, z)}|=|T(z)E_{S}_{_{y′}}(x, y)|

|E_{z′(x, y, z)}|=|T(z)E_{S}_{_{z′}}(x, y)| (2)

where T may, as an example, be given by:

T(z)=f⁻¹P(z)f. (3)

Here, f is the 2-D Fourier transform operator, which when applied to the electric field components gives:

$${\tilde{E}}_{{S}_{{x}^{′} , {y}^{′} , {z}^{′}}} ( {k}_{x} , {k}_{y} , z ) = \frac{1}{2 π} \int {\int }_{{R}^{2}} {E}_{{S}_{{x}^{′} , {y}^{′} , {z}^{′}}} ( x , y , z ) {e}^{i ( {k}_{x} x + {k}_{y} y )} d x d y . \qquad ( 4 )$$

The field over the phantom surface is assumed to be bounded within the phantom and null outside. Therefore the integral can be calculated as the integral over the bottom of the phantom boundary.

The Fourier-transformed field is also called plane wave spectrum (PWS). In this example, the operator P is the planar propagator function of the PWS, defined as:

P(z)=e−i\sqrt{k₀²ε−(|kₓ|²+|k_{y}|²)(z−z₀)} (5)

Where k₀ is the wave number in free space, and ε=ε′−jε″ denotes the effective dielectric constant of the tissue simulating liquid.

To avoid inaccuracies due to strong coupling effects between the measurement probe and the phantom shell, the field cannot be measured directly on the surface of the phantom. Thus, in a particular embodiment, the single planar or curved surface 31 is separate from a boundary of the phantom 30. In another particular embodiment, the single planar or curved surface 31 is located at a non-zero distance from a boundary of the phantom 30. In a particularly preferred embodiment, the measurements are performed at a distance z=z₀ above the bottom surface of the phantom to reduce the coupling effects (typically z₀≈3 mm).

In a particular embodiment, the electric field is propagated inside the phantom above the measurement plane, preferably for z>z₀, using a propagation function. With reference to FIG. 1A and FIG. 1B, the field is propagated from the single planar or curved surface 31 inside the phantom, towards a first boundary surface 32 of the phantom 30. As illustrated in FIG. 1B, the first boundary surface 32 may be the top surface of the phantom 30 in an embodiment. In this way, a volumetric distribution of the complex electric field in a first part of the phantom 30 is obtained. The volumetric distribution of the electric field strength \sqrt{|E_{x′}|²+|E_{y′}|²+|E_{z′}|²} in the first part of the phantom 30 is then used to extrapolate the field from the single planar or curved surface 31 towards a second boundary surface 33 of the phantom 30. As illustrated in FIG. 1B, the second boundary surface may be the bottom surface of the phantom 30 in an embodiment. In this way a volumetric distribution of the complex electric field in a second part of the phantom 30 is obtained. The thus determined volumetric distribution of the complex electric field in the two parts of the phantom is in this embodiment then used to determine the whole-body SAR.

In other words, in a particular embodiment and with reference to FIG. 3, the step S200 of estimating a whole-body SAR in the phantom 30 comprises a first step S210 of propagating, using a propagation function, the determined complex electric field in the plurality of points into a first part of the volume of the phantom 30, where the first part of the volume extends from the single planar or curved surface 31 to a first boundary surface 32 of the phantom 30, to obtain a first volumetric distribution of the complex electric field in the first part of the volume of the phantom 30. In a second step S220 the determined complex electric field in the plurality of points is extrapolated, based on the first volumetric distribution of the complex electric field, into a second part of the volume of the phantom 30, where the second part of the volume extends from the single planar or curved surface 31 to a second boundary surface 33 of the phantom 30, to obtain a second volumetric distribution of the complex electric field in the second part of the volume of the phantom 30. In a final step S230 a whole-body SAR in the phantom 30 is determined based on the first volumetric distribution of the complex electric field and the second volumetric distribution of the complex electric field.

A list of suitable extrapolation techniques for this case can be found in the international standard IEC 62209-1 CDV, “Human exposure to radio frequency fields from hand-held and body-mounted wireless communication devices-human models, instrumentation, and procedures—part 1: Procedures to determine the specific absorption rate (SAR) for hand-held devices used in close proximity to the ear (frequency range of 300 MHz to 3 GHz)”, 2011.

In a particular example embodiment and with reference to FIG. 4, the step S230 of determining a whole-body SAR in the phantom 30 comprises a first step S231 of calculating a dissipated power in the phantom 30 based on the first volumetric distribution of the complex electric field and the second volumetric distribution of the complex electric field, and a second step S232 of calculating the whole-body SAR in the phantom 30 based on the calculated dissipated power in the phantom 30.

For example, the total dissipated power, P_{A}, and subsequently the whole-body SAR, SAR_{wb}, are calculated from the amplitude of the electric field distribution within the phantom using the equations

$$\begin{matrix}{P}_{A} = {\int }_{V} σ ( {\vert {E}_{{x}^{′}} ( x , y , z ) \vert}^{2} + {\vert {E}_{{y}^{′}} ( x , y , z ) \vert}^{2} + {\vert {E}_{{z}^{′}} ( x , y , z ) \vert}^{2} ) d V & ( 6 ) \\ SARwb = \frac{{P}_{A}}{m} & ( 7 )\end{matrix}$$

where σ and m denote the phantom liquid conductivity and the appropriate body mass, respectively. The integral in equation (6) is to be taken over the entire phantom volume V.

In a particular embodiment, and with reference to FIG. 1A and FIG. 1B, the wireless communication device 40 is positioned below the phantom, in proximity to the bottom surface 33 of the phantom. The measurements are performed in points belonging to a single surface 31 within the phantom, in proximity to the bottom surface 33 of the phantom. In other words, in a particular embodiment the wireless communication device 40 is positioned closer to the second boundary surface 33 (corresponding to the bottom surface in FIG. 1A and FIG. 1B) than to the first boundary surface 32 (corresponding to the top surface in FIG. 1A and FIG. 1B). In another particular embodiment, the single planar or curved surface 31 is positioned closer to the second boundary surface 33 than to the first boundary surface 32.

In a preferred embodiment, the single planar or curved surface 31 is substantially parallel to the first boundary surface 32 and/or the second boundary surface 33. However, in another embodiment the single planar or curved surface 31 may be non-parallel with regard to the first boundary surface 32 and/or the second boundary surface 33.

In a preferred example embodiment, the measured electric field components are three orthogonal components of the electric field, as illustrated in FIG. 1A.

According to specifications of the international standard IEC 62232, SAR should be measured within a rectangular box-shaped phantom with a length and width of approximately 1.5 m and 0.34 m, respectively. Thus, in a preferred example embodiment, the phantom 30 is a cubiod. However, the disclosed method may also be implemented using other phantom shapes.

In order for a phantom used in SAR measurements to be a valid model for a human body, the fluid inside the phantom should have similar dielectric properties as human tissue, i.e. high loss and high permittivity. Also, the constant phase assumption of the disclosed method is justified because of the high loss and high permittivity of the fluid inside the phantom. Thus, in a preferred example embodiment, the phantom 30 comprises a fluid with dielectric properties equivalent to human tissue.

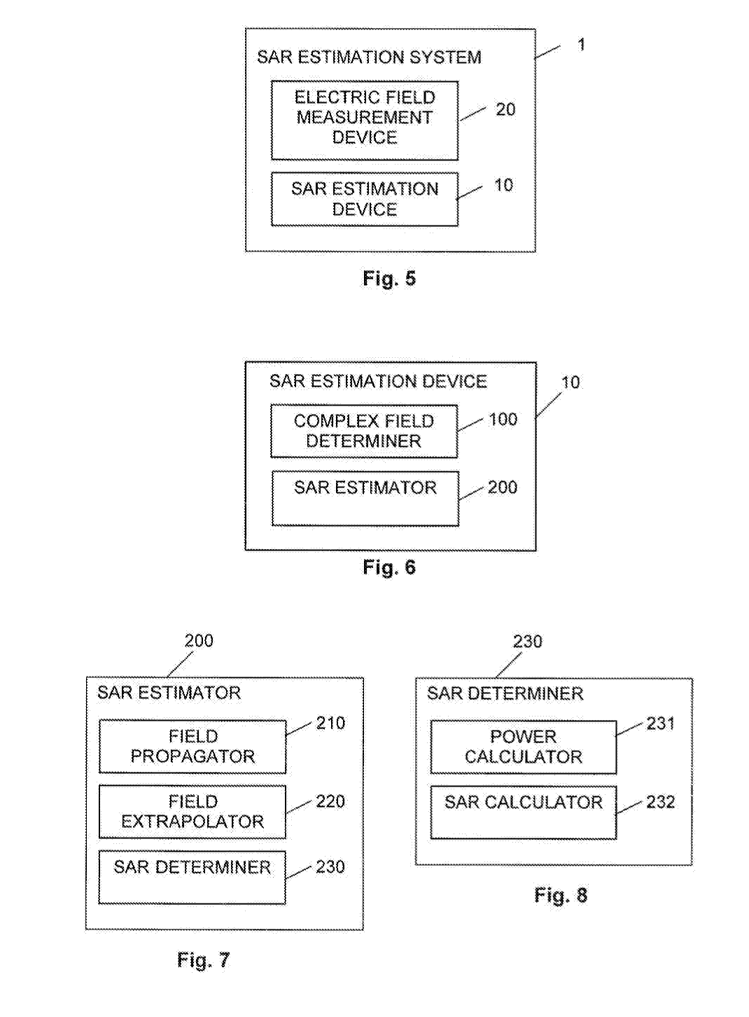

FIG. 5 is a block diagram of an embodiment of a SAR estimation system 1, configured to estimate a whole-body SAR caused in a body by electromagnetic fields emitted by a wireless communication device 40, where the body is represented by a phantom 30 and the wireless communication device 40 is placed in the proximity of the phantom 30. The SAR estimation system 1 comprises an electric field measurement device 20 configured to measure the magnitude of electric field components in a plurality of points distributed substantially in a single planar or curved surface 31 within the phantom 30. The SAR estimation system also comprises a SAR estimation device 10, which is described in further detail below.

FIG. 6 is a block diagram of an embodiment of a SAR estimation device 10 configured to estimate a whole-body SAR caused in a body by electromagnetic fields emitted by a wireless communication device 40, where the body is represented by a phantom 30 and the wireless communication device 40 is placed in the proximity of the phantom 30. The SAR estimation device 10 comprises a complex field determiner 100 configured to determine a complex electric field in a plurality of points distributed substantially in a single planar or curved surface 31 within the phantom 30, based on measurements of the magnitude of the electric field components in the plurality of points, and based on an assumption of constant phase of the electric field components. The SAR estimation device 10 also comprises a SAR estimator 200 configured to estimate a whole-body SAR in the phantom 30 based on the determined complex electric field in the plurality of points, and based on propagation of the complex electric field from the plurality of points into the volume of the phantom 30.

To avoid inaccuracies due to strong coupling effects between the measurement probe and the phantom shell, the field cannot be measured directly on the surface of the phantom. Thus, in a particular embodiment, the complex field determiner 100 is configured to determine a complex electric field in a plurality of points distributed substantially in a single planar or curved surface 31 which is separate from a boundary of the phantom 30. In another particular embodiment, the complex field determiner 100 is configured to determine a complex electric field in a plurality of points distributed substantially in a single planar or curved surface 31 which is located at a non-zero distance from a boundary of the phantom 30. In a particularly preferred embodiment, the complex field determiner 100 is configured to determine a complex electric field in a plurality of points distributed substantially in a single planar or curved surface 31 at a distance z=z₀ above the bottom surface of the phantom to reduce the coupling effects (typically z₀≈3 mm).

FIG. 7 is a block diagram of an embodiment of the SAR estimator in FIG. 6. In a particular embodiment, as described above, the field is propagated from the single planar or curved surface 31 inside the phantom, towards a first boundary surface 32 of the phantom 30. In this way, a volumetric distribution of the complex electric field in a first part of the phantom 30 is obtained. The thus determined volumetric distribution of the electric field in the first part of the phantom 30 is then used to extrapolate the electric field from the single planar or curved surface 31 towards a second boundary surface 33. In this way a volumetric distribution of the complex electric field in a second part of the phantom 30 is obtained. The thus determined volumetric distribution of the complex electric field in the two parts of the phantom is in this embodiment then used to determine the whole-body SAR.

Thus, in the embodiment shown in FIG. 7, the SAR estimator 200 comprises a field propagator 210 configured to propagate, using a propagation function, the determined complex electric field in the plurality of points into a first part of the volume of the phantom 30, where the first part of the volume extends from the single planar or curved surface 31 to a first boundary surface 32 of the phantom 30, to obtain a first volumetric distribution of the complex electric field in the first part of the volume of the phantom 30. The SAR estimator 200 further comprises a field extrapolator 220 configured to extrapolate, based on the first volumetric distribution of the complex electric field, the determined complex electric field in the plurality of points into a second part of the volume of the phantom 30, where the second part of the volume extends from the single planar or curved surface 31 to a second boundary surface 33 of the phantom 30, to obtain a second volumetric distribution of the complex electric field in the second part of the volume of the phantom 30. The SAR estimator 200 also comprises a SAR determiner 230 configured to determine a whole-body SAR in the phantom 30 based on the first volumetric distribution of the complex electric field and the second volumetric distribution of the complex electric field.

FIG. 8 is a block diagram of an embodiment of the SAR determiner 230 in FIG. 7. In this embodiment, the SAR determiner 230 comprises a power calculator 231 configured to calculate a dissipated power in the phantom 30 based on the first volumetric distribution of the complex electric field and the second volumetric distribution of the complex electric field. The SAR determiner 230 also comprises a SAR calculator 232 configured to calculate a whole-body SAR in the phantom 30 based on the dissipated power in the phantom 30.

In a particular embodiment, and with reference to FIG. 1A and FIG. 1B, the wireless communication device 40 is positioned below the phantom, in proximity to the bottom surface 33 of the phantom. The measurements are performed in points belonging to a single surface 31 within the phantom, in proximity to the bottom surface 33 of the phantom. In other words, in a particular embodiment, the complex field determiner 100 is configured to determine a complex electric field in a plurality of points distributed substantially in a single planar or curved surface 31 within the phantom 30, based on magnitude measurements of electric field components emitted by a wireless communication device 40 which is positioned closer to the second boundary surface 33 (corresponding to the bottom surface in FIG. 1A and FIG. 1B) than to the first boundary surface 32 (corresponding to the top surface in FIG. 1A and FIG. 1B). In another particular embodiment, the complex field determiner 100 is configured to determine a complex electric field in a plurality of points distributed substantially in a single planar or curved surface 31 which is positioned closer to the second boundary surface 33 than to the first boundary surface 32.

In a preferred embodiment, the complex field determiner 100 is configured to determine a complex electric field in a plurality of points distributed substantially in a single planar or curved surface 31 which is substantially parallel to the first boundary surface 32 and/or the second boundary surface 33. However, in another embodiment the complex field determiner 100 is configured to determine a complex electric field in a plurality of points distributed substantially in a single planar or curved surface 31 which may be non-parallel with regard to the first boundary surface 32 and/or the second boundary surface 33.

In a preferred embodiment, the complex field determiner 100 is configured to determine a complex electric field in a plurality of points distributed substantially in a single planar or curved surface 31 within the phantom 30, based on magnitude measurements of three orthogonal components of the electric field in the plurality of points.

The units 100-200 of the SAR estimation device 10 can be implemented in hardware, in computer-executable software, or as a combination thereof. Although the respective units 100-200 disclosed in conjunction with FIG. 6 have been disclosed as physically separate units 100-200 in the SAR estimation device 10, and all may be special purpose circuits, such as ASICs (Application Specific Integrated Circuits), alternative embodiments are possible where some or all of the units 100-200 are implemented as computer program modules running on a general purpose computer processor.

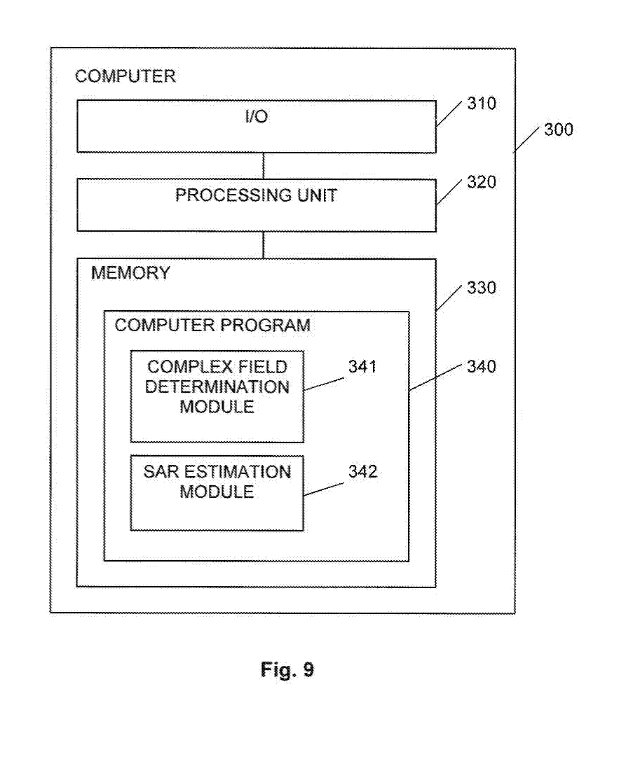

In the latter case and with reference to FIG. 9, the SAR estimation device 10 can be implemented in a computer 300 comprising a general input/output (I/O) unit 310 in order to enable communication with the electric field measurement device 20, a processing unit 320, such as a DSP (Digital Signal Processor) or CPU (Central Processing Unit). The processing unit 320 can be a single unit or a plurality of units for performing different steps of the method described herein. The computer 300 also comprises at least one computer program product 330 in the form of a non-volatile memory, for instance an EEPROM (Electrically Erasable Programmable Read-Only Memory), a flash memory or a disk drive. The computer program product 330 in an embodiment comprises computer readable program means and a computer program 340, stored on the computer readable program means, for estimating, when executed by a computer, a whole-body SAR caused in a body by electromagnetic fields emitted by a wireless communications device, where the body is represented by a phantom 30 and the wireless communication device 40 is placed in the proximity of the phantom 30.

The computer program 340 comprises program means 341-342 which when run by a processing unit 320 of the SAR estimation device 10, causes the processing unit 320 to perform the steps of the method described in the foregoing in connection with FIG. 2. Hence, in an embodiment the computer program 340 comprises program means 341 configured to determine a complex electric field in a plurality of points distributed substantially in a single planar or curved surface 31 within the phantom 30, based on measurements of the magnitude of the electric field components in the plurality of points, and based on an assumption of constant phase of the electric field components. The computer program 340 also comprises program means 342 configured to estimate a whole-body SAR in the phantom 30 based on the determined complex electric field in the plurality of points, and based on propagation of the complex electric field from the plurality of points into the volume of the phantom 30.

The embodiments as disclosed herein can be used to significantly reduce the total SAR evaluation time; in a particular application from approximately 13 hours to approximately 1.5 hours. In addition, the embodiments are suitable for integration with commercially available SAR measurement systems, without requiring any additional instrumentation. The embodiments are also suitable for integration with the IEC 62232 standard.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1-25. (canceled)

26. A method for estimating a whole-body Specific Absorption Rate (SAR) caused in a body by electromagnetic fields emitted by a wireless communication device, the body being represented by a phantom and the wireless communication device being positioned in the proximity of the phantom, the method comprising:
determining a complex electric field in a plurality of points distributed substantially in a single planar or curved surface within the phantom, based on measurements of a magnitude of electric field components in said plurality of points, and based on an assumption of constant phase of the electric field components; and
estimating a whole-body SAR in the phantom based on the determined complex electric field in said plurality of points, and based on propagation of the determined complex electric field from said plurality of points into the volume of the phantom.

27. The method according to claim 26, wherein said single planar or curved surface is separate from a boundary of the phantom.

28. The method according to claim 26, wherein said single planar or curved surface is located at a non-zero distance from a boundary of the phantom.

29. The method according to claim 26, wherein estimating a whole-body SAR in the phantom comprises:
propagating, using a propagation function, the determined complex electric field in said plurality of points into a first part of the volume of the phantom, said first part of the volume extending from said single planar or curved surface to a first boundary surface of the phantom, to obtain a first volumetric distribution of the determined complex electric field in said first part of the volume of the phantom;
extrapolating, based on said first volumetric distribution of the determined complex electric field, the determined complex electric field in said plurality of points into a second part of the volume of the phantom, said second part of the volume extending from said single planar or curved surface to a second boundary surface of the phantom, to obtain a second volumetric distribution of the determined complex electric field in said second part of the volume of the phantom; and
determining a whole-body SAR in the phantom based on said first volumetric distribution of the determined complex electric field and said second volumetric distribution of the determined complex electric field.

30. The method according to claim 29, wherein determining a whole-body SAR in the phantom comprises:
calculating a dissipated power in the phantom based on said first volumetric distribution of the determined complex electric field and said second volumetric distribution of the determined complex electric field; and
calculating a whole-body SAR in the phantom based on the calculated dissipated power in the phantom.

31. The method according to claim 26, wherein said single planar or curved surface is positioned closer to said second boundary surface than to said first boundary surface.

32. The method according to claim 26, wherein said wireless communication device is positioned closer to said second boundary surface than to said first boundary surface.

33. The method according to claim 26, wherein said single planar or curved surface is substantially parallel to at least one of said first boundary surface and said second boundary surface.

34. The method according to claim 26, wherein said single planar or curved surface is non-parallel with regard to at least one of said first boundary surface and said second boundary surface.

35. The method according to claim 26, wherein said electric field components are three orthogonal components of the determined complex electric field.

36. The method according to claim 26, wherein the phantom is a cuboid.

37. The method according to claim 26, wherein the phantom comprises a fluid with dielectric properties equivalent to human tissue.

38. A Specific Absorption Rate (SAR) estimation device configured to estimate a whole-body SAR caused in a body by electromagnetic fields emitted by a wireless communication device, the body being represented by a phantom and the wireless communication device being placed in the proximity of the phantom, comprising:
a complex field determiner circuit configured to determine a complex electric field in a plurality of points distributed substantially in a single planar or curved surface within the phantom, based on measurements of a magnitude of electric field components in said plurality of points, and based on an assumption of constant phase of the electric field components; and
a SAR estimator circuit configured to estimate a whole-body SAR in the phantom based on the determined complex electric field in said plurality of points, and based on propagation of the determined complex electric field from said plurality of points into the volume of the phantom.

39. The SAR estimation device according to claim 38, wherein said complex field determiner circuit is configured to determine the complex electric field in a plurality of points distributed substantially in a single planar or curved surface that is separate from a boundary of the phantom.

40. The SAR estimation device according to claim 38, wherein said complex field determiner circuit is configured to determine the complex electric field in a plurality of points distributed substantially in a single planar or curved surface that is located at a non-zero distance from a boundary of the phantom.

41. The SAR estimation device according to claim 38, wherein said SAR estimator circuit is configured to:
propagate, using a propagation function, the determined complex electric field in said plurality of points into a first part of the volume of the phantom, said first part of the volume extending from said single planar or curved surface to a first boundary surface of the phantom, to obtain a first volumetric distribution of the determined complex electric field in said first part of the volume of the phantom;
extrapolate, based on said first volumetric distribution of the determined complex electric field, the determined complex electric field in said plurality of points into a second part of the volume of the phantom, said second part of the volume extending from said single planar or curved surface to a second boundary surface of the phantom, to obtain a second volumetric distribution of the determined complex electric field in said second part of the volume of the phantom; and
determine a whole-body SAR in the phantom based on said first volumetric distribution of the determined complex electric field and said second volumetric distribution of the determined complex electric field.

42. The SAR estimation device according to claim 41, wherein said SAR estimator circuit is configured to:
calculate a dissipated power in the phantom based on said first volumetric distribution of the determined complex electric field and said second volumetric distribution of the determined complex electric field; and
calculate a whole-body SAR in the phantom based on the calculated dissipated power in the phantom.

43. The SAR estimation device according to claim 38, wherein said complex field determiner circuit is configured to determine the complex electric field in a plurality of points distributed substantially in a single planar or curved surface that is positioned closer to said second boundary surface than to said first boundary surface.

44. The SAR estimation device according to claim 38, wherein said complex field determiner circuit is configured to determine the complex electric field in a plurality of points distributed substantially in a single planar or curved surface within the phantom, based on magnitude measurements of electric field components emitted by a wireless communication device that is positioned closer to said second boundary surface than to said first boundary surface.

45. The SAR estimation device according to claim 38, wherein said complex field determiner circuit is configured to determine the complex electric field in a plurality of points distributed substantially in a single planar or curved surface that is substantially parallel to at least one of said first boundary surface and said second boundary surface.

46. The SAR estimation device according to claim 38, wherein said complex field determiner circuit is configured to determine the complex electric field in a plurality of points distributed substantially in a single planar or curved surface that is non-parallel with regard to at least one of said first boundary surface and said second boundary surface.

47. The SAR estimation device according to claim 38, wherein said complex field determiner circuit is configured to determine the complex electric field in a plurality of points distributed substantially in a single planar or curved surface within the phantom, based on magnitude measurements of three orthogonal components of the complex electric field in said plurality of points.

48. A Specific Absorption Rate (SAR) estimation system configured to estimate a whole-body SAR caused in a body by electromagnetic fields emitted by a wireless communication device, the body being represented by a phantom and the wireless communication device being placed in the proximity of the phantom, wherein the SAR estimation system comprises:
an electric field measurement device configured to measure a magnitude of electric field components in a plurality of points distributed substantially in a single planar or curved surface within the phantom; and
a SAR estimation device configured to:
determine a complex electric field in a plurality of points distributed substantially in a single planar or curved surface within the phantom, based on measurements of a magnitude of electric field components in said plurality of points, and based on an assumption of constant phase of the electric field components; and
estimate a whole-body SAR in the phantom based on the determined complex electric field in said plurality of points, and based on propagation of the determined complex electric field from said plurality of points into the volume of the phantom.

49. A non-transitory computer readable medium storing a computer program for estimating a whole-body Specific Absorption Rate (SAR) caused in a body by electromagnetic fields emitted by a wireless communication device, the body being represented by a phantom and the wireless communication device being placed in the proximity of the phantom, the computer program comprising program instructions that, when executed by at least one processor, cause the at least one processor to:
determine a complex electric field in a plurality of points distributed substantially in a single planar or curved surface within the phantom, based on measurements of a magnitude of the electric field components in said plurality of points, and based on an assumption of constant phase of the electric field components; and
estimate a whole-body SAR in the phantom based on the determined complex electric field in said plurality of points, and based on propagation of the determined complex electric field from said plurality of points into the volume of the phantom.
